(19) United States
(12) Patent Application Publication
(10) Pub. No.: US 2020/0410589 A1
(43) Pub. Date: Dec. 31, 2020

(54) System for Generating Interactive User Interface

(71) Applicant: TD Ameritrade IP Company, Inc., Omaha, NE (US)

(72) Inventors: Sari Lynne HARRIS, Brooklyn, NY (US); Matthew Robert GUARRACINO, Carmel, NY (US)

(21) Appl. No.: 16/452,464

(22) Filed: Jun. 25, 2019

(51) Int. Cl. G06Q 40/04

(52) U.S. Cl. CPC G06Q 40/04

(57) ABSTRACT

A transaction management system includes a communication interface configured to receive, from a user device, a dollar amount to be spent on a selected investment product and a transaction control module. The transaction control module is configured to calculate, based on the received dollar amount and a price per share of the selected investment product, a highest number of whole shares of the selected investment product that can be purchased for the received dollar amount and selectively update the calculated highest number of whole shares in response to adjustments to the received dollar amount and the price per share of the selected investment product. The communication interface is further configured to transmit, for display on the user device, the calculated highest number of whole shares.

### FIELD

The present disclosure relates to systems and user interfaces for facilitating the purchase of investment products.

### BACKGROUND

As the popularity of online trading increases, various sources provide websites and/or other user interfaces for buying and selling investment products (e.g., shares of stocks). For example, users may select a number of shares of a particular stock to buy. Conversely, users may select a number of shares of an already-owned stock to sell. In this manner, investment transactions may be completed via an online user interface.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A transaction management system includes a communication interface configured to receive, from a user device, a dollar amount to be spent on a selected investment product and a transaction control module. The transaction control module is configured to calculate, based on the received dollar amount and a price per share of the selected investment product, a highest number of whole shares of the selected investment product that can be purchased for the received dollar amount and selectively update the calculated highest number of whole shares in response to adjustments to the received dollar amount and the price per share of the selected investment product. The communication interface is further configured to transmit, for display on the user device, the calculated highest number of whole shares.

In other features, the transaction control module is further configured to communicate with an investment system via the communication interface to selectively update the calculated highest number of whole shares in response to adjustments to the price per share of the selected investment product. The transaction control module is further configured to provide, via the communication interface, contents of a transaction cart to be displayed on the user device. The transaction control module is further configured to selectively update the calculated highest number of whole shares of the selected investment product as displayed in the contents of the transaction cart. The transaction control module is further configured to receive adjustments to the received dollar amount input via the transaction cart and selectively update the calculated highest number of whole shares of the selected investment product as displayed in the contents of the transaction cart in response to the adjustments received via the transaction cart.

In other features, the transaction control module is further configured to provide, via the communication interface and to be displayed on the user device, at least one of a transaction cart page in response to a request to display the transaction cart page, a checkout page in response to a request to advance to the checkout page, a review order page in response to a request to complete a transaction, and a purchase confirmation page. The transaction control module is configured to update the calculated highest number of whole shares in response to adjustments to the price per share of the selected investment product as displayed in each of the transaction cart page, the checkout page, the review order page, and the purchase confirmation page.

In other features, a system includes the transaction management system and further includes the user device. The transaction control module is configured to communicate with a content database via the communication interface to provide educational content to be displayed on the user device. The educational content includes at least one of a risk assessment of the selected investment product and a summary of recommendations from a plurality of analysts regarding the selected investment product.

A method for conducting an investment transaction includes receiving, at a communication interface of a transaction management system, a dollar amount to be spent on a selected investment product, calculating, based on the received dollar amount and a price per share of the selected investment product, a highest number of whole shares of the selected investment product that can be purchased for the received dollar amount, selectively updating the calculated highest number of whole shares in response to adjustments to the received dollar amount and the price per share of the selected investment product, and transmitting, for display on a user device, the calculated highest number of whole shares.

In other features, the method further includes communicating with an investment system via the communication interface to selectively update the calculated highest number of whole shares in response to adjustments to the price per share of the selected investment product. The method further includes providing, via the communication interface, contents of a transaction cart to be displayed on the user device. The method further includes selectively updating the calculated highest number of whole shares of the selected investment product as displayed in the contents of the transaction cart. The method further includes receiving adjustments to the received dollar amount input via the transaction cart and selectively updating the calculated highest number of whole shares of the selected investment product as displayed in the contents of the transaction cart in response to the adjustments received via the transaction cart.

In other features, the method further includes providing, via the communication interface and to be displayed on the user device, at least one of a transaction cart page in response to a request to display the transaction cart page, a checkout page in response to a request to advance to the checkout page, a review order page in response to a request to complete a transaction, and a purchase confirmation page. The method updates the calculated highest number of whole shares in response to adjustments to the price per share of the selected investment product as displayed in each of the transaction cart page, the checkout page, the review order page, and the purchase confirmation page.

In other features, the method further includes communicating with a content database via the communication interface to provide educational content to be displayed on the user device. The educational content includes at least one of a risk assessment of the selected investment product and a summary of recommendations from a plurality of analysts regarding the selected investment product.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a block diagram of an example network communication system configured to implement a dollar-based investment product transaction system and method according to the principles of the present disclosure.

FIG. 2 is a block diagram of an example transaction management system and user device configured to implement a dollar-based investment product transaction system and method according to the principles of the present disclosure.

FIGS. 3A, 3B, 3C, 3D, 3E, and 3F illustrate an example user device configured to implement a user to conduct a transaction according to the principles of the present disclosure.

FIGS. 4A, 4B, 4C, 4D, 4E, 4F, 4G, and 4H illustrate an example user interface configured to display information in response to a search conducted by a user and executed by a transaction management system according to the principles of the present disclosure.

FIG. 5 is a flowchart illustrating an example method for conducting a dollar-based investment product transaction according to the principles of the present disclosure.

In the drawings, reference numbers may be reused to identify similar and/or identical elements.

### DETAILED DESCRIPTION

Typically, users conduct transactions to buy and sell investment products on a per-share basis. In other words, a user may select a particular stock and a number of shares of the selected stock to buy or sell. Conducting transactions in this manner may be difficult when purchasing stocks having varied and fluctuating prices. For example, it may be desirable for users to approach transactions based on overall dollar values associated with a particular transaction (e.g., including purchases and sales of multiple, differently priced stocks). However, this approach may be difficult when transactions are conducted on a per-share basis and include multiple stocks and multiple types of transactions (e.g., both purchases and sales of stocks). Further, stock prices may fluctuate during the time it takes to complete a transaction.

A dollar-based investment product transaction system and method according to the principles of the present disclosure facilitates transactions by providing a user interface for searching for a product (e.g., a stock) and conducting transactions based on a desired purchase amount (e.g., a maximum dollar amount that a user would like to spend for purchases in a transaction). For example, a user may input a dollar amount to spend in a transaction and selected stocks may be presented with a whole number of shares (e.g., rounded down) that can be purchased with the input dollar amount.

The user may then add the presented number of shares (or, if desired, fewer or more of the shares) to a cart (i.e., an online, ecommerce shopping cart) for purchase. The actual dollar amount displayed via the user interface is updated in accordance with the selected number of shares. A difference between the updated dollar amount and the dollar amount input initially input by the user may also be displayed. The updated dollar amount is further updated (e.g., recalculated periodically, when the user advances to a next or previous page, etc.) in accordance with any variation of the per share price of the stock that may occur during the transaction. In some examples, if the price increases such that the selected number of shares exceeds the dollar amount input by the user, whole shares may be subtracted from the number of shares added to the cart. In this manner, the updated dollar amount for the transaction does not exceed the desired spending amount of the user.

Similarly, the updated dollar amount may be adjusted to reflect shares of already owned stocks that the user selects to sell in the transaction. For example, the user interface may display a dollar amount that corresponds to a difference (e.g., positive or negative) between the dollar amount of purchases and the dollar amount of sales. In other examples, the user interface may separately display the dollar amount in purchases of the selected number of shares, the dollar amount in sales, and the difference between the dollar amount of purchases and the dollar amount of sales.

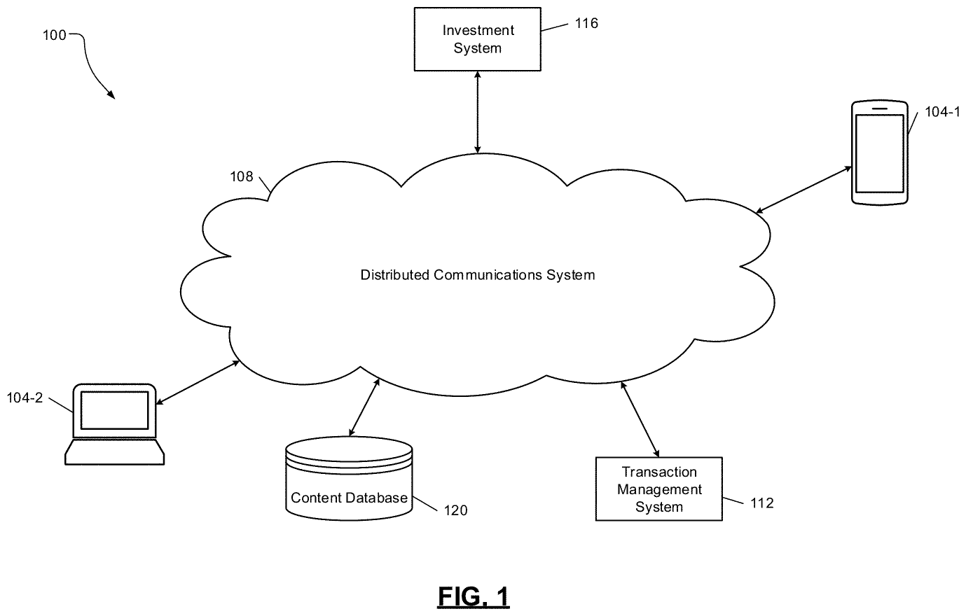

FIG. 1 is an example a network communication system 100 configured to implement a dollar-based investment product transaction system and method according to the principles of the present disclosure. One or more user devices—for example, a first user device 104-1 and a second user device 104-2 (collectively, user devices 104)—may be used to access an investment account via a distributed communication system (DCS) 108, such as the Internet, and a respective user interface. For example, the user devices 104 may include a smartphone or other mobile device as shown at 104-1, a mobile or desktop computing device as shown at 104-2, etc. The user devices 104 are configured to execute and display the respective user interfaces, receive inputs, etc.

The system 100 includes a transaction management system 112 configured to access an investment system 116 via the DCS 108 to retrieve stock prices, complete transactions to buy and sell investment products such as shares of stocks, etc. The investment system 116 may be an online broker, server, transaction database, etc. A content database 120 may store information such as educational content. The transaction management system 112 communicates with the user devices 104 to execute user interfaces on the user devices 104, receive inputs, display information, etc. as described below in more detail. For example, the transaction management system 112 receives search requests (e.g., for information about stocks, investing, etc.), transaction requests, etc. from the user devices 104. The transaction management system 112 communicates with the investment system 116 and/or the content database 120 to retrieve transaction information (e.g., stock prices) and educational content and to negotiate and complete transactions based on the requests received from the user devices 104. The transaction management system 112 provides information to be displayed on the user devices 104 based on the requests.

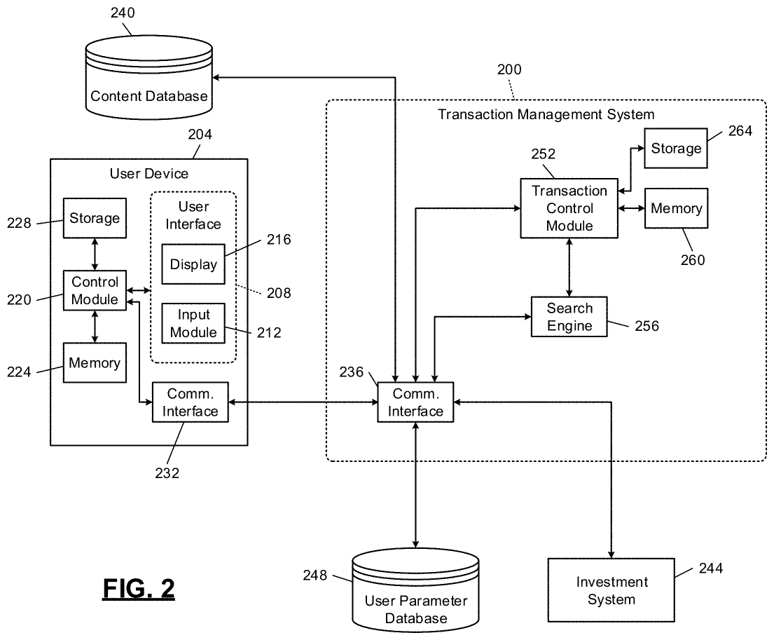

FIG. 2 shows an example implementation of a transaction management system 200 and user device 204 configured to implement the dollar-based investment product transaction system and method according to the principles of the present disclosure. For simplicity, the DCS 108 of FIG. 1 is not shown. The user device 204 implements a user interface 208 configured to receive inputs from and display information to a user. For example, the user interface 208 includes an input module 212 configured to receive inputs entered via a touchscreen and/or buttons, a physical or virtual keyboard, voice commands, etc. Conversely, the user interface 208 includes a display 216 configured to display information to the user. In some examples, the user interface 208 corresponds to a touchscreen configured to both receive inputs and display information and images.

The user device 204 includes a control module 220 configured to control functions of the user device 204, including, but not limited to, implementing the user interface 208. For example, the control module 220 may correspond to a processor configured to execute software instructions stored in memory 224 and/or high capacity storage 228.

The user device 204 communicates with the transaction management system 200 via a communication interface 232 (e.g., a wireless communication interface, a cellular communication interface, etc.). Conversely, the transaction management system 200 communicates with the user device 204 via a communication interface 236. The transaction management system 200 also communicates with a content database 240, an investment system 244, and, in some examples, a user parameter database 248. For example, the user parameter database 248 may store data corresponding to respective users of the transaction management system 200, such as user preferences, account information, user, transaction history, etc.

The transaction management system 200 includes a transaction control module 252 configured to control functions of the transaction management system 200, including, but not limited to, communicating with the user device 204, the content database 240, the investment system 244, and/or the user parameter database 248 to conduct transactions and executing a search engine 256 to search the content database 240 and the investment system 244. For example, the transaction control module 252 may correspond to a processor configured to execute software instructions stored in memory 260 and/or high capacity storage 264.

In some examples, the transaction control module 252 is configured to access the investment system 244 to retrieve stock prices, complete transactions to buy and sell investment products such as shares of stocks, etc. in response to requests received from the user device 204 via the user interface 208. For example, the transaction control module 252 receives search requests, transaction requests, etc. from the user device 204 in response to inputs received via the user interface 208. The transaction control module 252 communicates with the investment system 244 and/or the content database 240 to retrieve transaction information and educational content and to negotiate and complete transactions based on the requests received from the user device 204. In some examples, searches and transactions may be performed in response to the requests and further based on information stored in the user parameter database 248.

Conversely, the transaction control module 252 provides information to be displayed on the user device 204 based on the results of the requests. For example, the transaction control module 252 provides information including, but not limited to, educational content and transaction information to the user device 204 as described below in more detail.

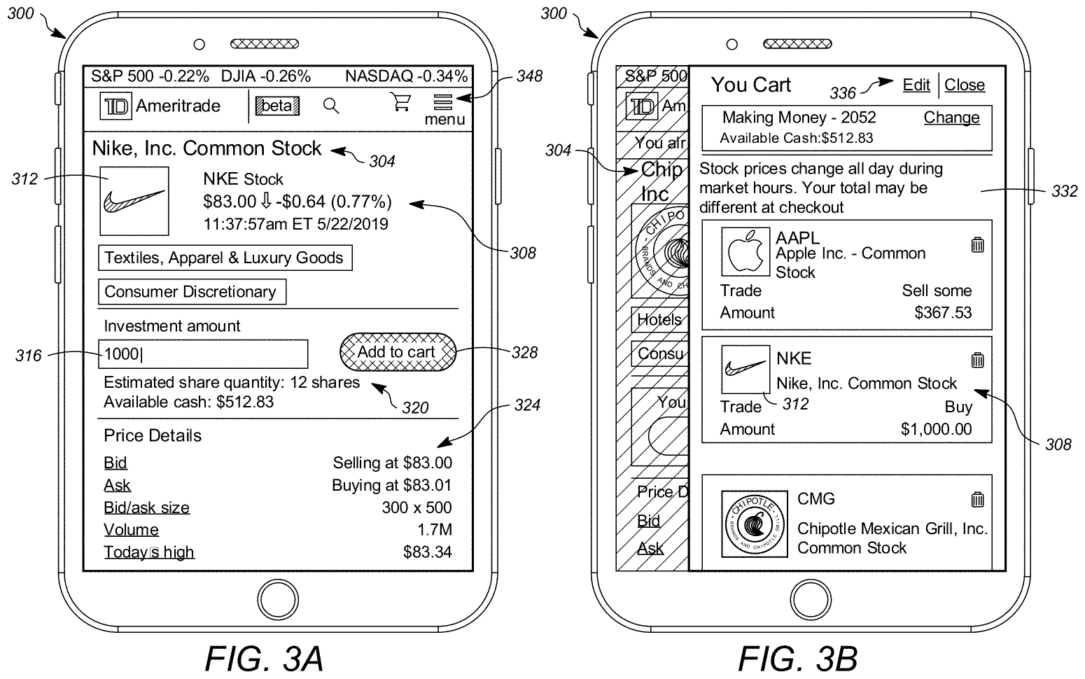

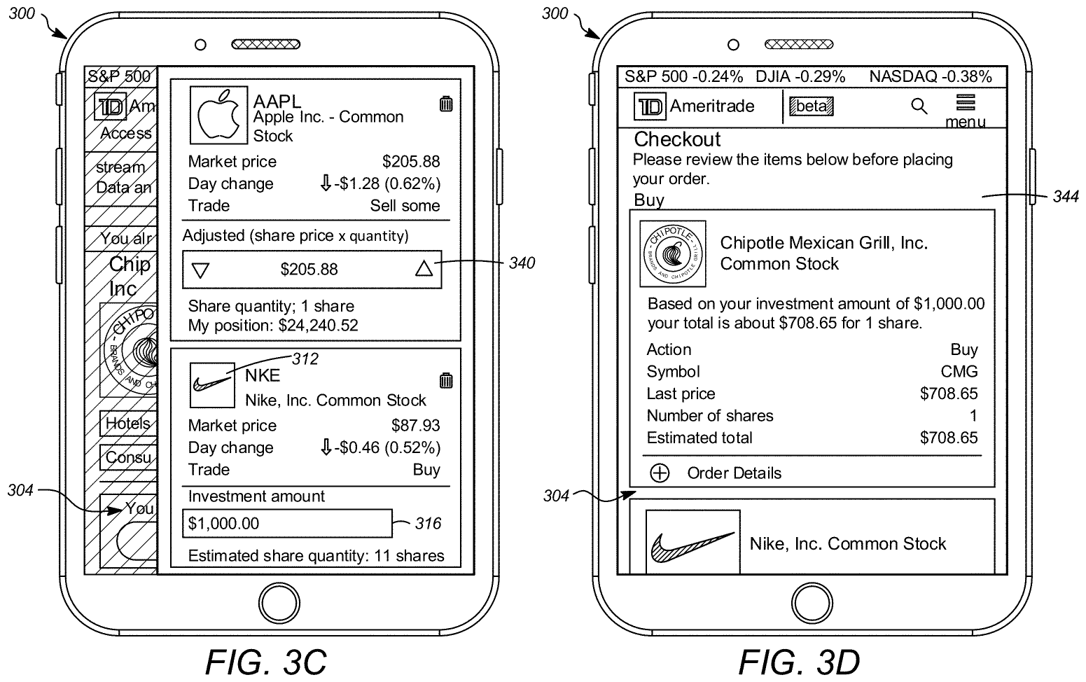

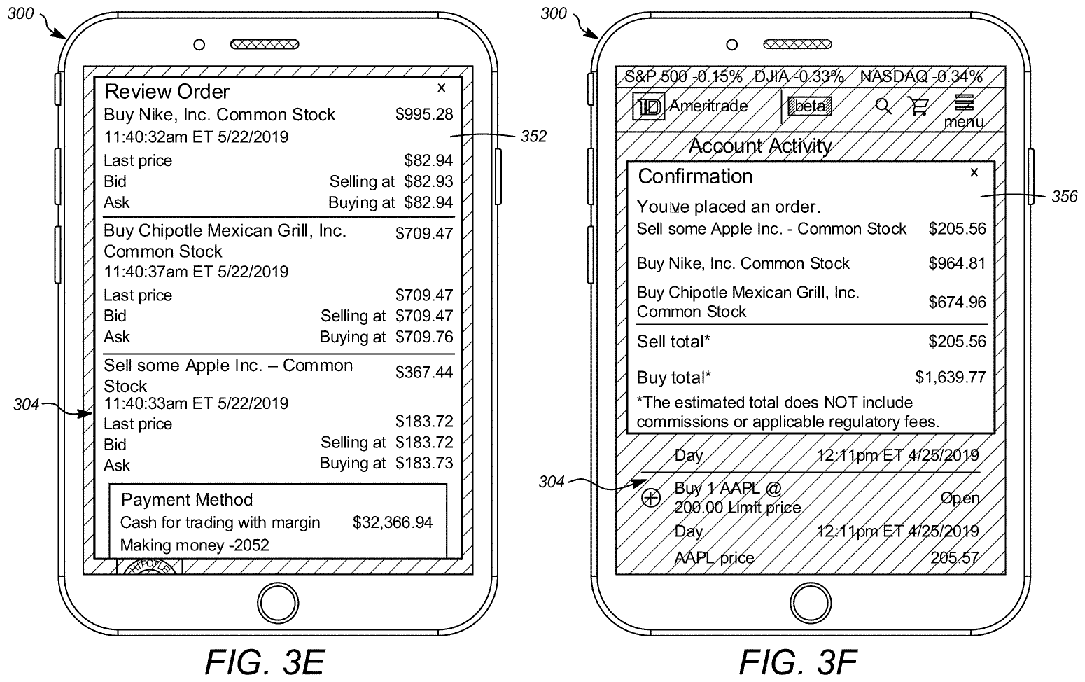

Referring now to FIGS. 3A, 3B, 3C, 3D, 3E, and 3F, and with continued reference to FIG. 2, an example implementation of a user device 300 is shown. The user device 300 may correspond to the user device 204 and is configured to implement a user interface 304 (which may correspond to the user interface 208). The user interface 304 permits a user to conduct a transaction according to the present disclosure. For example only, the user interface 304 corresponds to a touchscreen display configured to both display information and receive inputs from a user.

As shown in FIG. 3A, the user device 300 may display stock information 308 about a selected stock in response to a search or request for the stock input by the user. For example, the stock information 308 may include a name of the stock, a logo 312, a price per share, a change in the price per share, a time that the price per share was last updated, a brief description (e.g., a type and/or category of the stock), etc.

A user may input a desired dollar amount to spend on the stock in an investment amount input field 316. An estimated share quantity 320 is displayed based on the desired dollar amount input by the user. For example, the transaction management system 200 (e.g., the transaction control module 252) receives the desired dollar amount and calculates (i.e., rounds down to) a highest number of whole shares that can be purchased for the input dollar amount. Price details 324 (e.g., a selling price, a buying price, etc.) may be displayed.

As user may select an “add to cart” button 328 to add the indicated quantity of shares to a transaction cart 332 as shown in FIG. 3B. The cart 332 displays the dollar amount of each stock selected to purchase and/or a dollar amount of any stocks selected to sell. Accordingly, the cart 332 may display multiple stock purchase, sales, and combinations thereof. As shown in FIG. 3C, the user may edit (e.g., by clicking an edit button 336) the dollar amount in the investment amount input field 316 from within the cart 332 and the estimated share quantity 320 is updated automatically. For example, the transaction management system 200 may update the estimated share quantity 320 in response to adjustments to the investment amount input field 316. Accordingly, if the price per share increased or decreased sufficiently to cause the maximum whole number of shares that can be purchased for the input dollar amount to decrease or increase, the displayed share quantity 320 is updated. An adjustment user interface (UI) element 340 allows the user to adjust the quantity of shares to sell or total sale amount within the cart 332. The adjustment UI element 340 shows the user the total sale amount for the quantity of shares being sold (calculated as share price×quantity).

A checkout page 344 is shown in FIG. 3D. For example only, the user may select a checkout button (not shown) from a dropdown menu 348, the cart 332, etc. to advance to the checkout page 344. The checkout page 344 displays, for example, the quantity, price per share, and total price of each stock being purchased and sold during the transaction. The quantity, price per share, and total price of each stock being purchased may again be updated by the transaction management system 200 to reflect any changes in the price per share (e.g., in response to the user advancing to the checkout page 344).

The user may advance to a review order page 352 (e.g., by selecting a purchase or buy button (not shown) on the checkout page 344) as shown in FIG. 3E. The review order page 352 displays updated (i.e., as again updated by the transaction management system 200) sale and purchase prices her share and total dollar amounts of sales and purchases for each stock being sold and/or purchased in the transaction. The user may complete the transaction (e.g., by selection a complete transaction button (not shown)) to advance to a purchase confirmation page 356 as shown in FIG. 3F. The purchase confirmation page 356 may display the respective dollar amount of each sale and purchase as well as total sale and purchase dollar amounts. The dollar amounts displayed on the purchase confirmation page 356 may again be updated (e.g., by the transaction management system 200) to reflect any changes to sale and/or purchase prices per share. Accordingly, sale and purchase dollar amounts per share and total dollar amount of shares being sold and purchased are updated by the transaction management system 200 in response to adjustments and requests input by the user as well as in response to transitions between respective pages of the user interface 304. Further, the initial dollar amount input by the user in the investment amount input field 316 provides a maximum dollar amount that cannot be exceeded (unless edited) as the user progresses through the transaction.

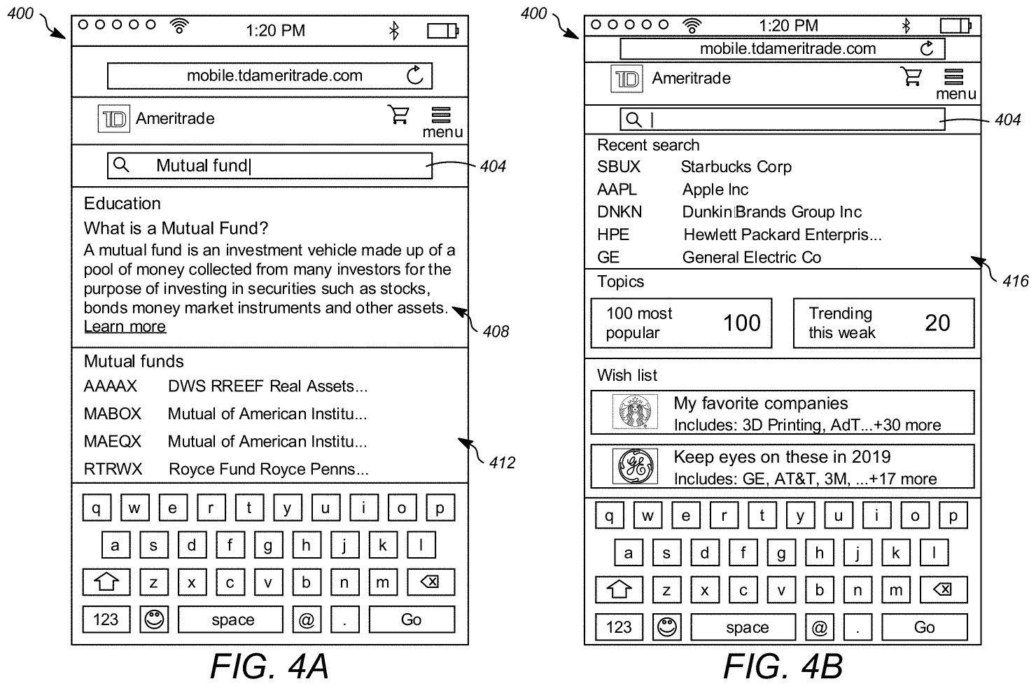

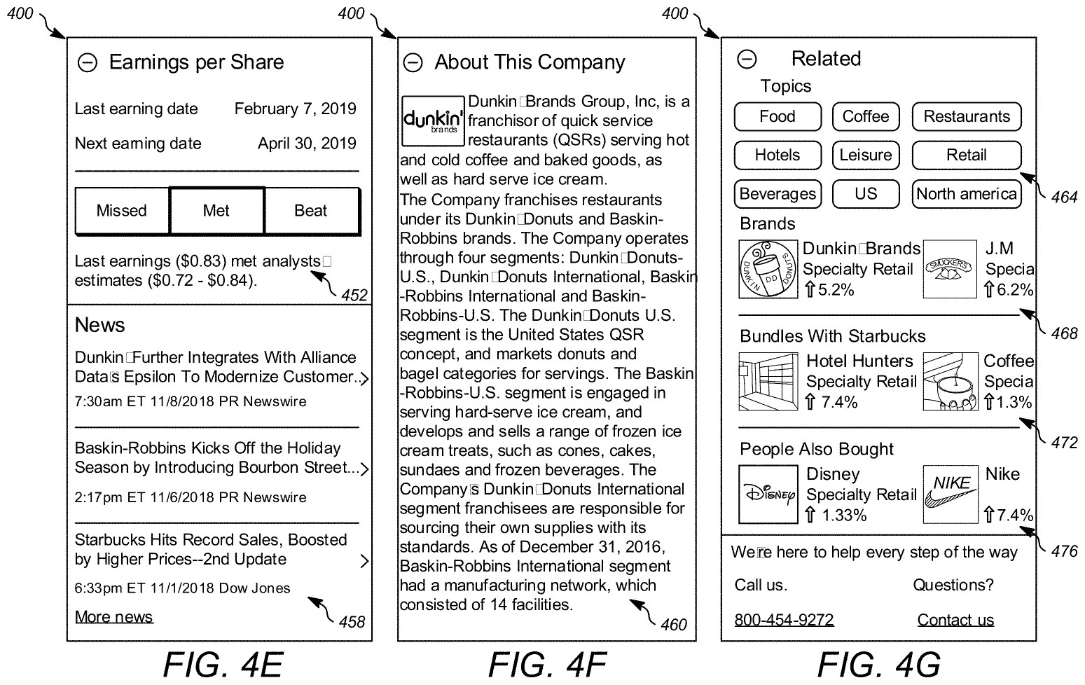

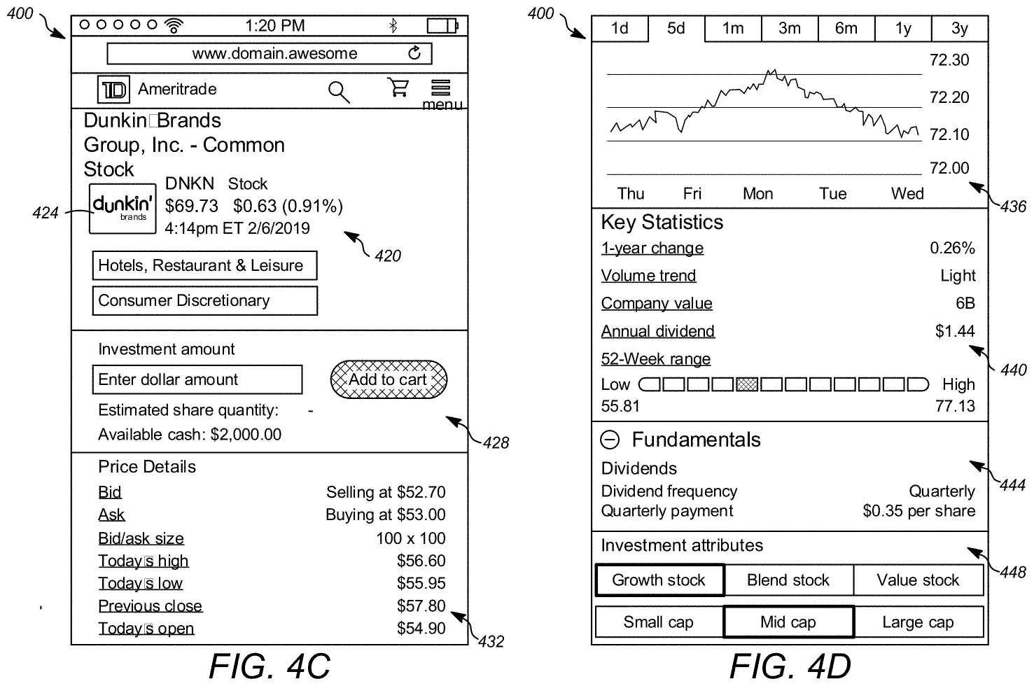

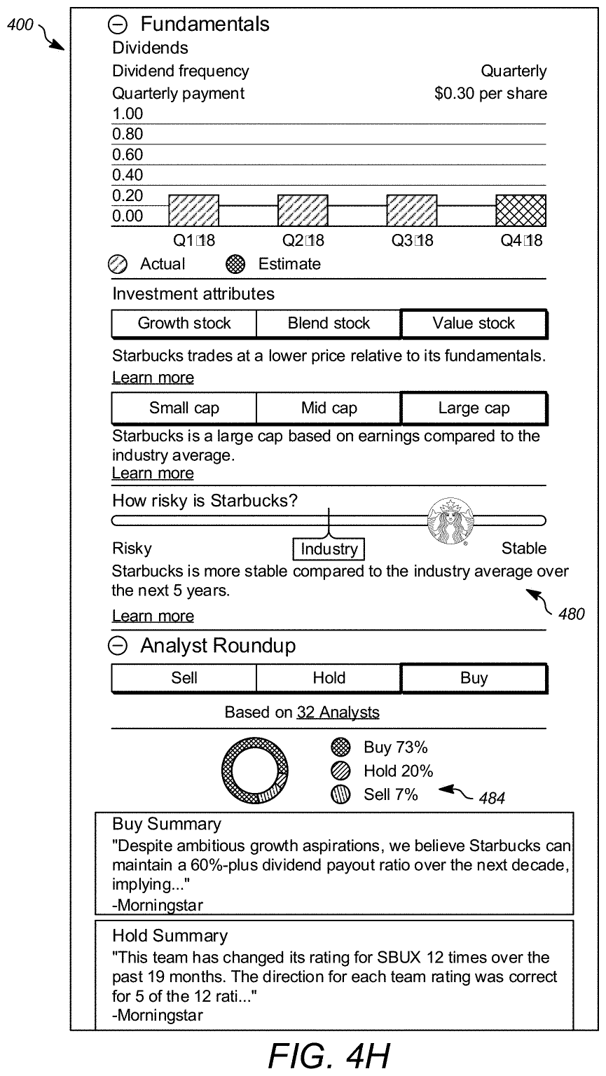

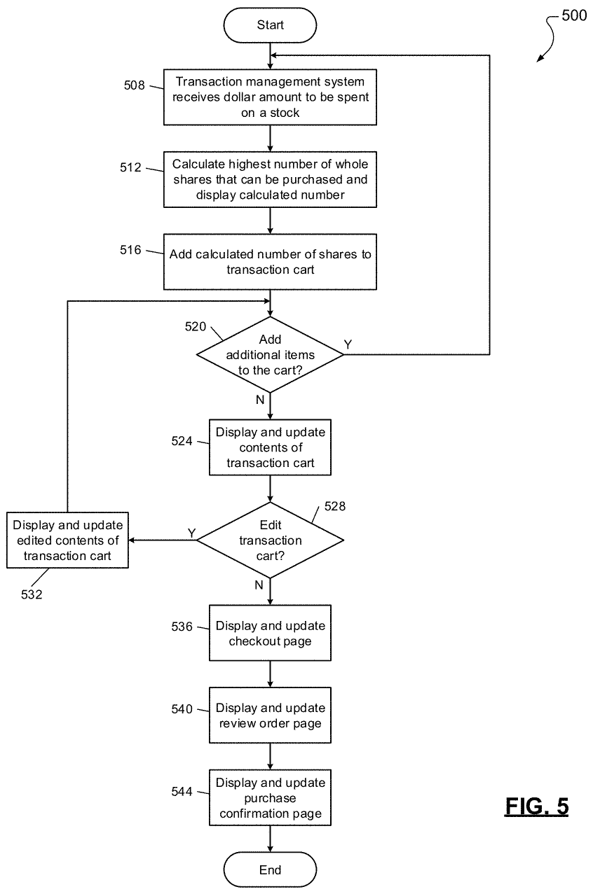

FIGS. 4A, 4B, 4C, 4D, 4E, 4F, 4G, and 4H illustrate an example implementation of a user interface 400 (e.g., as implemented by the user device 300 and responsive to the transaction management system 200) configured to display information in response to a search conducted by the user and executed by the transaction management system 200. For example, as shown in FIG. 4A, the user may input keywords into a search field 404 to conduct a search for information about a particular topic (e.g., “mutual funds”). The transaction management system 200 may provide information in response to the search to be displayed via the user interface 400. For example, the transaction management system 200 may receive a search request and conduct a search of the content database 120 accordingly. The information provided by the transaction management system 200 to the user interface 400 may include educational content 408 (e.g., a definition or summary of the searched topic). When appropriate, the information may include selectable investment (i.e., purchase) options 412 related to the searched topic. For example, when the searched topic is “mutual funds,” the investment options 412 may include various mutual funds. Similarly, if the searched topic is “tech stocks,” the investment options may include various technology stocks.

As shown in FIG. 4B, the user may search by a particular stock name and/or type of stock, and/or may select a stock from a list 416 (e.g., a list of recently search stocks). In response to the user selecting a stock, the user interface 400 may display information about the selected stock (i.e., as provided by the transaction management system 200 in response to the request) as shown in FIGS. 4C, 4D, 4E, 4F, and 4G. For example, as shown in FIG. 4C, the user interface 400 may display stock information 420 (including a logo 424), investment amount and share information 428, and price details 432 similar to the user interface 304 described in FIG. 3A.

The user may scroll down the user interface 400 to view additional information. For example, as shown in FIG. 4D, the information may include performance information 436, selected statistics 440, dividend information 444, and investment attributes 448. As shown in FIGS. 4E, 4F, and 4G, the information may include earnings information 452, news items 456 (which may each be selectable to retrieve additional information), company information 460, related topics 464, related brands 468, a pane 472 showing bundles including the selected stock, a pane 476 showing other stocks purchased by users who also bought the selected stock, etc. For example, the related topics 464 may be selectable to retrieve additional information and/or additional stocks related to the selected topic.

In some examples, the information may include a risk assessment 480 and/or an analyst roundup 484 as shown in FIG. 4H. For example, the risk assessment 480 may illustrate a riskiness or stability of the selected stock relative to an industry standard. Conversely, the analyst roundup 484 may illustrate respective percentages of industry analysts recommending whether to buy, hold, or sell the selected stock.

Referring now to FIG. 5, an example method 500 for conducting a dollar-based investment product transaction according to the principles of the present disclosure begins at 508. For example only, the method 500 is implemented using the transaction management system 200 and user device 204 as described above in FIG. 2. At 508, the method 500 receives a dollar amount to be spent on a selected stock. For example, the transaction management system 200 receives the dollar amount as input into the investment amount input field 316 of the user interface 304. At 512, the method 500 (e.g., the transaction management system 200) calculates a highest number of whole shares that can be purchased for the input dollar amount and displays the calculated number of shares via the user interface 304. At 516, the method 500 (e.g., the transaction management system 200) adds the calculated number of shares of the stock to a transaction cart (e.g., in response to the user selecting the “add to cart” button 328).

At 520, the method 500 (e.g., the transaction management system 200) determines whether to add additional items to the transaction cart. For example, the user may search for and select a different stock, input a desired dollar amount to spend on that stock, etc. If true, the method 500 continues to 508. If false, the method 500 continues to 524. At 524, the method 500 (e.g., the transaction management system 200, via the user device 204) displays and updates the contents of the transaction cart (e.g., in response to a request from the user to display the contents of the cart). Updating the contents of the cart includes updating the price per share of each stock in the cart and recalculating the highest number of whole shares that can be purchased for the input dollar amount.

At 528, the method 500 (e.g., the transaction management system 200) determines whether to edit the transaction cart (e.g., in response to a request from the user). If true, the method 500 continues to 532. If false, the method 500 continues to 536. At 532, the method 500 (e.g., the transaction management system 200) updates and displays the edited contents of the cart (e.g., in response to user inputs). For example, the transaction management system 200 may add items to the cart or remove items from the cart and update a number of shares of stocks to be sold or purchased (e.g., in response to changes in a price per share of the stock, an adjustment to the desired dollar amount input by the user, etc.). The method 500 may then continue to 520.

At 536, the method 500 displays and updates a checkout page (e.g., in response to the user selecting a checkout button). The checkout page displays, for example, the quantity, price per share, and total price of each stock being purchased and sold during the transaction. The quantity, price per share, and total price of each stock being purchased may again be updated by the transaction management system 200 to reflect any changes in the price per share (e.g., in response to the user advancing to the checkout page). The method 500 advances from the checkout page to a review order page at 540. The review order page displays updated (i.e., as again updated by the transaction management system 200) sale and purchase prices her share and total dollar amounts of sales and purchases for each stock being sold and/or purchased in the transaction.

At 544, the method 500 advances to a purchase confirmation page. The purchase confirmation page may display the respective dollar amount of each sale and purchase as well as total sale and purchase dollar amounts. The dollar amounts displayed on the purchase confirmation page may again be updated (e.g., by the transaction management system 200) to reflect any changes to sale and/or purchase prices per share. The method 500 then ends.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A transaction management system comprising:
a communication interface configured to receive, from a user device, a dollar amount to be spent on a selected investment product; and
a transaction control module configured to
calculate, based on the received dollar amount and a price per share of the selected investment product, a highest number of whole shares of the selected investment product that can be purchased for the received dollar amount, and
selectively update the calculated highest number of whole shares in response to adjustments to the received dollar amount and the price per share of the selected investment product,
wherein the communication interface is further configured to transmit, for display on the user device, the calculated highest number of whole shares.

2. The transaction management system of claim 1 wherein:
the transaction control module is further configured to communicate with an investment system via the communication interface to selectively update the calculated highest number of whole shares in response to adjustments to the price per share of the selected investment product.

3. The transaction management system of claim 1 wherein:
the transaction control module is further configured to provide, via the communication interface, contents of a transaction cart to be displayed on the user device.

4. The transaction management system of claim 3 wherein:
the transaction control module is further configured to selectively update the calculated highest number of whole shares of the selected investment product as displayed in the contents of the transaction cart.

5. The transaction management system of claim 3 wherein:
the transaction control module is further configured to receive adjustments to the received dollar amount input via the transaction cart and selectively update the calculated highest number of whole shares of the selected investment product as displayed in the contents of the transaction cart in response to the adjustments received via the transaction cart.

6. The transaction management system of claim 1 wherein:
the transaction control module is further configured to provide, via the communication interface and to be displayed on the user device, at least one of
a transaction cart page in response to a request to display the transaction cart page,
a checkout page in response to a request to advance to the checkout page,
a review order page in response to a request to complete a transaction, and
a purchase confirmation page; and
the transaction control module is configured to update the calculated highest number of whole shares in response to adjustments to the price per share of the selected investment product as displayed in each of the transaction cart page, the checkout page, the review order page, and the purchase confirmation page.

7. A system comprising the transaction management system of claim 1 and further comprising the user device.

8. The transaction management system of claim 1 wherein:
the transaction control module is configured to communicate with a content database via the communication interface to provide educational content to be displayed on the user device.

9. The transaction management system of claim 8 wherein the educational content includes at least one of a risk assessment of the selected investment product and a summary of recommendations from a plurality of analysts regarding the selected investment product.

10. A method for conducting an investment transaction, the method comprising:
receiving, at a communication interface of a transaction management system, a dollar amount to be spent on a selected investment product;
calculating, based on the received dollar amount and a price per share of the selected investment product, a highest number of whole shares of the selected investment product that can be purchased for the received dollar amount,
selectively updating the calculated highest number of whole shares in response to adjustments to the received dollar amount and the price per share of the selected investment product; and
transmitting, for display on a user device, the calculated highest number of whole shares.

11. The method of claim 10 further comprising communicating with an investment system via the communication interface to selectively update the calculated highest number of whole shares in response to adjustments to the price per share of the selected investment product.

12. The method of claim 10 further comprising providing, via the communication interface, contents of a transaction cart to be displayed on the user device.

13. The method of claim 12 further comprising selectively updating the calculated highest number of whole shares of the selected investment product as displayed in the contents of the transaction cart.

14. The method of claim 12 further comprising receiving adjustments to the received dollar amount input via the transaction cart and selectively updating the calculated highest number of whole shares of the selected investment product as displayed in the contents of the transaction cart in response to the adjustments received via the transaction cart.

15. The method of claim 10 further comprising providing, via the communication interface and to be displayed on the user device, at least one of
a transaction cart page in response to a request to display the transaction cart page,
a checkout page in response to a request to advance to the checkout page,
a review order page in response to a request to complete a transaction, and
a purchase confirmation page,
wherein the method updates the calculated highest number of whole shares in response to adjustments to the price per share of the selected investment product as displayed in each of the transaction cart page, the checkout page, the review order page, and the purchase confirmation page.

16. The method of claim 10 further comprising communicating with a content database via the communication interface to provide educational content to be displayed on the user device.

17. The method of claim 16 wherein the educational content includes at least one of a risk assessment of the selected investment product and a summary of recommendations from a plurality of analysts regarding the selected investment product.
